(19) United States
(12) Patent Application Publication
(10) Pub. No.: US 2024/0100878 A1
(43) Pub. Date: Mar. 28, 2024

(54) METHOD FOR THE PRODUCTION OF A COMPONENT

(71) Applicant: MERCEDES-BENZ GROUP AG, Stuttgart (DE)

(72) Inventors: Lars SCHMOHL, Oberboihingen (DE); Martina GAYDUSCHEK, Nürnberg (DE); Martin STIEFEL, Ehningen (DE); Christoph SROWIG, Aidlingen (DE); Jens GOEDECKE, Sindelfingen (DE)

(21) Appl. No.: 18/036,935

(22) PCT Filed: Nov. 3, 2021
(86) PCT No.: PCT/EP2021/080461

§ 371 Date: May 15, 2023

(30) Foreign Application Priority Data
Nov. 16, 2020 (DE) 10 2020 007 010.8

(51) Int. Cl. B44B 5/02; C14B 1/56; D06C 23/04; G06Q 30/0601

(52) U.S. Cl. CPC B44B 5/026; C14B 1/56; D06C 23/04; G06Q 30/0621; B33Y 80/00

(57) ABSTRACT

A method for producing a component involves producing a die using an additive production process. A design is embossed in a component material layer of the component by the die. The design is selected and/or created by a customer. This design selected and/or created by the customer is then submitted to an additive production process that produces the die, via a digital platform, which the customer accesses by a customer terminal or via a user program on the customer terminal. The die is then produced by the additive production device in the additive production process corresponding to the submitted design.

### BACKGROUND AND SUMMARY OF THE INVENTION

Exemplary embodiments of the invention relate to a method for the production of a component.

DE 10 2015 216 325 A1 discloses method for the production of a decorative component having a raised, embossed visible surface, as well as a decorative component produced by the method. An embossing device having a female embossing mold and a male embossing mold, as well as at least one decorative layer of material is provided in the method. The decorative layer of material is arranged between the female embossing mold and the male embossing mold in such a way that a visible surface of the decorative layer of material is facing the female embossing mold and a back side surface of the decorative layer of material opposite the visible surface is facing the male embossing mold. An embossing process is subsequently carried out by means of the embossing device, so that the decorative layer of material has a raised region on the visible surface and an opposed indented region on the back side surface after the embossing process. For stabilizing the raised region, an insertion element is arranged in the indented region.

US 2005/0053275 A1 discloses a method in which an embossed object is created from a two-dimensional picture. The stamp used for embossing is thereby produced by means of a 3D printer.

Exemplary embodiments of the invention are directed to an improved method for the production of a component compared to the prior art.

In a method for the production of a component, a die is produced by means of an additive production process, for example by means of 3D printing, and a design is embossed in a component material layer by means of the die.

According to the invention, the design is selected and/or created by a customer. This design selected and/or created by the customer is then submitted to an additive production process, by means of which the die is produced in the additive production process, via a digital platform, which the customer accesses by means of a customer terminal, or via a user program, also referred to as an application, or app for short, on the customer terminal. The die is then produced by means of the additive production device in the additive production process corresponding to the submitted design. Corresponding to the submitted design can mean, in particular, that the die is advantageously produced as a negative of the submitted design, in order to correspondingly produce the design as a positive on the component. The customer terminal is, for example, a mobile telephone or computer, in particular a so-called smartphone, a PC, a tablet computer or a notebook. The selection and/or creation of the design by the customer can, for example, occur on the digital platform or in the user program.

The die is thereby provided with an adhesive layer and remains on the back side of the component material layer that faces away from the visible side as a stiffening element after the embossing.

The method according to the invention enables an individualization of the component by means of an individual embossing corresponding to the requirements of the customer, i.e., corresponding to the design selected and/or created by them. In particular, the production of such components is thereby enabled from a quantity of one, i.e., no serially produced products need to be produced, and, advantageously, corresponding to the enabled individualization, no serially produced products are produced either.

By means of the method according to the invention, all conceivable graphic details can advantageously be realized, for example lettering or logos.

In a possible embodiment of the method, using digital data from the design selected and/or created by the customer, a quality and/or an achievability of the design on the component and/or an achievability of the production of the die corresponding to this design is, advantageously automatically and advantageously mechanically, checked. This can, for example, occur by means of the digital platform or by means of the user program. It is thereby ensured that the design can actually be created on the component, in particular that it can be created with a predetermined minimum quality.

In a possible embodiment of the method, in particular after this checking and based on results of this checking, the digital data from the design selected and/or created by the customer is supplemented and/or corrected, in particular regarding depth information and/or regarding a picture quality. The creation of the design on the component can thereby be enabled, in particular also then if the creation of the design on the component with the original digital data from the design selected and/or created by the customer were not possible, for example due to a too-poor picture quality and/or due to lacking or incorrect depth information. The correspondingly supplemented and/or corrected design selected and/or created by the customer is then advantageously submitted to the additive production device.

The design is advantageously embossed on one side in the component material layer by means of the die, in particular in a visible side of the component material layer. No female mold and male mold are thus needed, rather only an individual die, and only this individual die is produced in the manner described above.

Advantageously, the component material layer is warmed before the embossing. The embossing is thereby enabled or at least facilitated, a durability of the embossed design is ensured, damages to the component material layer are prevented by means of the embossing and a good quality of the design in the component is ensured.

For example, the design is embossed in a component material layer formed as a flat material by means of the die, in particular in a component material layer formed from leather or textiles.

For example, a component for a vehicle is produced by means of the method described above, for example a component formed as a vehicle interior component, for example a component formed as a seat cover or headrest cover or floor mat or fabric lining. An individualization of vehicles according to customers' wishes is thereby enabled in a cost-effective way, for example even when buying a vehicle, in particular a new vehicle, or at any time as a retrofit option or as a replacement of a component already present in the vehicle by the component individualized by means of the method. The user program and/or the digital platform are thereby advantageously provided by a vehicle manufacturer and/or vehicle dealers. By means of the method described, a better customer relationship is, in particular, achieved.

### BRIEF DESCRIPTION OF THE DRAWING FIGURES

Exemplary embodiments of the invention are illustrated in greater detail below by means of drawings.

Here are shown:

FIG. 1 a schematic process level of a method for the production of a component, and

FIG. 2 a schematic part of a method sequence of the method.

Parts that correspond to one another are provided with the same reference numerals in all figures.

### DETAILED DESCRIPTION

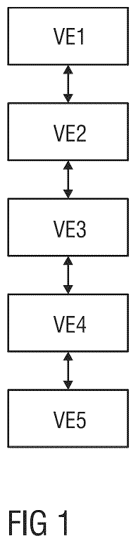

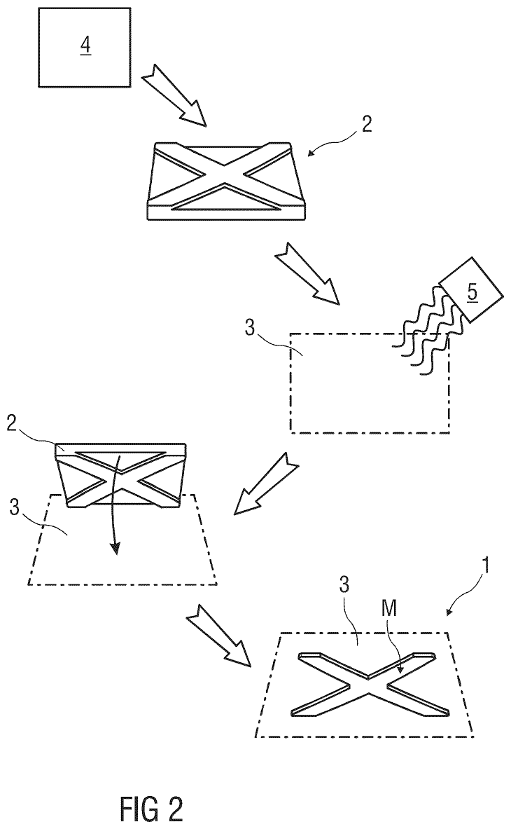

FIG. 1 shows five process levels VE1 to VE5 of a method for the production of a component 1. The upper three process levels VE1 to VE3 are thereby located in the digital world, i.e., process sequences advantageously occur purely digitally on these three process levels VE1 to VE3, and both lower process levels VE4, VE5 are located in the physical world, i.e., physical production processes occur here, initially for producing a die 2 and then for embossing a design M in a component material layer 3. The process sequence in these two lower process levels VE4, VE5 is shown in yet more detail in FIG. 2 and subsequently explained.

In the method described here for the production of the component 1, in particular for a vehicle, in particular for the production of a vehicle interior component, for example a seat cover or headrest cover or a floor mat or a fabric lining, the design M, which should be created on the component 1 by means of embossing the component 1, is selected and/or created by a customer. This occurs on the uppermost and thus first process level VE1 of the method and thus in the digital world. A digital service for the customers, in order to enable this, is made available to the customers, for example by a vehicle manufacturer and/or vehicle dealers, for example in the form of a digital platform or of a user program for a customer terminal. In particular in the digital platform, the vehicle dealers can, for example, be helpful to the customers and access this digital platform for the customers.

This design M selected and/or created by the customer is then submitted to an additive production device 4 via the digital platform, which the customer accesses by means of a customer terminal or, for example, the vehicle dealer accesses by means of a corresponding terminal at the request of the customer, or via the user program on the customer terminal. However, advantageously, even before this submission to the additive production device 4, using digital data from the design selected and/or created by the customer, a quality and/or an achievability of the design M on the component 1 and/or an achievability of the production of the die 2 corresponding to this design M is checked. This occurs on the second process level VE2, thus still in the digital world. For example, this can occur by means of the digital platform or by means of the user program.

In a possible embodiment, in particular after this checking and based on results of this checking, the digital data from the design M selected and/or created by the customer is supplemented and/or corrected, in particular regarding depth information and/or regarding a picture quality.

The design M selected and/or created by the customer, if necessary supplemented and/or corrected in the manner described above, is then submitted to an additive production device 4 via the digital platform, which the customer accesses by means of a customer terminal or, for example, the vehicle dealer accesses by means of a corresponding terminal at the request of the customer, or via the user program on the customer terminal. The additive production device 4 thus, in particular, receives data for a geometry of the die 2 to be produced. This submission occurs in the third process level VE3, which represents a connectivity level of the method.

The die is then, as shown in FIG. 2, produced by means of the additive production device 4 in an additive production process, for example 3D printing, corresponding to the submitted design M. This occurs in the fourth process level VE4, i.e., in the physical world.

By means of the die 2, the design M is then embossed in the component material layer 3, for example in a flat material, for example made of leather or textiles, in order to thereby produce the component 1. This occurs on the fifth process level VE5. To this end, the component material layer 3 is initially warmed or heated by means of a heating device 5 and subsequently, the die 2 is pressed onto the warmed or heated component material layer 3.

The warming of the component material layer 3 can thereby occur in different ways: Since the die 2, produced, for example, by means of a 3D printing process, has a worse thermal conductivity than metal stamps, there are some alternatives, in order to bring the material of the flat material, in particular the leather, to the necessary temperature (approx. 80 to 100° C.):

When using only one printed die 2, the component material layer 3 can be heated from the back side, the side facing away from the visible side, with a level metal stamp. If this is the case, the embossing process can here additionally occur in two force levels: In the first force level, the component material layer 3 is pressed gently onto the rear-side metal stamp with the help of the die 2, so that the component material layer 3 can heat through to its visible side. In a second force level, the actual embossing process is then carried out.

Alternatively, the component material layer 3 can be heated directly shortly before the embossing process, for example by means of an infrared heater, by means of microwave radiation or by means of hot air, or by means of warming up between heated plates or rollers.

It is furthermore possible to heat the die 2 instead. This can, for example, occur by means of infrared radiation. Advantageously, the material of the die 2 is thereby provided with dyes, which absorb in the infrared range, in order to accelerate the warming. Similarly, a heating of the additively produced die 2 can also occur with the help of microwave radiation, wherein an additive can be added to the material of the die 2 that absorbs microwave radiation and converts it into heat.

Alternatively, or additionally, the die can be provided with an electrically conductive and heatable layer.

The result is the completed component 1 with the embossed design M.

In the method described here, the design M is embossed on one side in the component material layer 3 by means of the die 2, in particular in a visible side of the component material layer 3. Therefore, no female mold and no male mold are used, rather only the single die 2.

As an alternative to this, female molds and male molds can, however, be used, thus making it a double-sided embossing process. In this manner, a raised design M can also be embossed on the component 1. After the embossing process, a curable liquid or viscous material can be used for stiffening the component 1, that fills into the indent created in the embossing, is smoothed from behind (e.g., with the help of gravity, a roller or by spreading), and is cured. The curing can thereby, for example, occur by means of UV curing, thermal curing or by means of thermal hardening.

In a further embodiment of the method, a die 2 is produced in the process level VE4 by means of the additive production device 4 in an additive production process, as described above. This is thereby provided with an adhesive layer on the side facing the component 1 in the later embossing process and is then used for embossing, so is embossed on one side into the back side of the component material layer 3 facing away from the visible side. Subsequently, after the embossing process, this additively produced die 2 remains on the back side of the component material layer 3 and serves as a stiffening element.

In order to optimize the embossing process described above, the die 2 can be provided with a coating with an electroplating layer after its production. In this manner, the durability of the die 2 can be increased.

Furthermore, the die 2 can consist of an entirely or partially bio-sourced material (e.g., polyurethane acrylate), in order to reduce the carbon usage in the production of the die 2 and thus when carrying out the method.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-9. (canceled)

10. A method, comprising:
receiving, by a digital platform from a customer terminal or via a user program on the customer terminal, a submission of a design that is selected by a customer or that is created by the customer;
producing, using an additive production process, a die based on the design; and
embossing, using the die, the design in a component material layer of a component,
wherein the die has an adhesive layer and wherein the die remains on a back side of the component material layer facing away from a visible side of the component material layer as a stiffening element after the embossing.

11. The method of claim 10, further comprising:
checking, using digital data from the design selected by or created by the customer, a quality of the design on the component, an achievability of the design on the component, or an achievability of the production of the die corresponding to the design.

12. The method of claim 11, wherein the digital data from the design selected or created by the customer is supplemented or corrected, wherein the supplementation or correction involves supplementing or correcting depth information or a picture quality.

13. The method of claim 10, wherein the design is embossed on one side in the component material layer by the die, wherein the one side is the visible side of the component material layer.

14. The method of claim 10, further comprising:
warming the component material layer before the embossing.

15. The method of claim 10, wherein the component material layer is a flat material.

16. The method of claim 10, wherein the component material layer is leather or a textile.

17. The method of claim 10, wherein the component is a vehicle interior component for a vehicle.

18. The method of claim 10, wherein the component is a seat cover, a headrest cover, a floor mat, or a fabric lining.
